(19) United States
(12) Patent Application Publication
(10) Pub. No.: US 2019/0123401 A1
(43) Pub. Date: Apr. 25, 2019

(54) METHOD AND APPARATUS FOR CHARGING A BATTERY

(71) Applicant: SIEMENS AKTIENGESELLSCHAFT, München (DE)

(72) Inventor: ANDRE ROMPE, BERLIN KAULSDORF (DE)

(21) Appl. No.: 16/089,673

(22) PCT Filed: Mar. 2, 2017
(86) PCT No.: PCT/EP2017/054905

§ 371 Date: Sep. 28, 2018

(30) Foreign Application Priority Data
Mar. 31, 2016 (DE) 10 2016 205 374.4

(51) Int. Cl. H01M 10/48; H02J 7/00; H02J 7/04; H01M 10/44

(52) U.S. Cl. CPC H01M 10/48; H02J 7/007; H01M 2220/20; H01M 10/443; H02J 7/045

(57) ABSTRACT

A method and an apparatus for charging a rechargeable battery permit the battery to be charged by using a charging current that is dependent on the state of charge of the battery. Therefore, the battery can be recharged quickly even in the case of a low state of charge of the battery.

The invention relates to a method for charging a rechargeable battery. The invention also relates to an apparatus for charging a rechargeable battery, having a control device, which is configured to monitor the charging current during operation of the apparatus.

Methods and apparatuses for charging rechargeable batteries are generally known. For example, batteries are charged according to the so-called CCCV method, in which the charging current and the charging voltage are kept constant over the entire charging process. However, the charging power depends on the present no-load voltage of the battery that is to be charged, with the result that batteries having a lower state of charge are charged using a lower charging power. The further the state of charge of the battery drops, the lower the charging power. This results in the time required to fully charge the battery extending proportionally as the state of charge drops.

If, for example, the battery of an electrically driven public service bus is intended to be charged according to the CCCV method, it may be that the battery of the public service bus is not fully recharged at a charging station at which the bus stops, for instance a bus stop. If the charge consumed during the journey between the charging stations is not fully added to the battery at the subsequent charging station, the state of charge of the battery continuously decreases. However, the decrease in the state of charge accelerates due to the proportionally extending charging time as the state of charge drops, with the result that the battery is increasingly discharged and can be charged increasingly less at the planned charging stops. Consequently, the operating range of the public service bus decreases.

The invention is therefore based on the object of providing a method and an apparatus for charging a rechargeable battery using which the battery can be recharged more quickly independently of the state of charge.

For the method mentioned at the beginning, the object is achieved by virtue of the fact that, in the method, the battery is charged using a charging current that is dependent on the state of charge of the battery. For the apparatus mentioned at the beginning, the object is achieved by virtue of the fact that the control device is configured to execute the method according to the invention in order to charge the battery.

As a result of the fact that the charging current is selected or prescribed depending on the state of charge, the charging current can be increased in the case of a low state of charge so that the battery can be charged using a charging power that is higher in comparison to the CCCV method.

The solution according to the invention can be further improved by various refinements, which are in each case advantageous individually, and, unless stated otherwise, can be combined with one another in any manner. The following text deals with these refinements and the advantages associated therewith.

For example, the charging current can be controlled in such a way that the product of the charging current and the no-load voltage of the battery is substantially constant. The product of the charging current and the no-load voltage is the charging power. Consequently, the battery can be charged independently of the state of charge thereof using a high, where possible constant or even the maximum permissible, charging power, as a result of which the time required for charging the battery is reduced.

As an alternative or in addition, the charging current can be controlled in such a way that the product of the charging current and the no-load voltage at the beginning of a charging cycle is greater than later or at the end of the charging cycle. For example, the charging power at the beginning of the charging cycle can be at least twice and, for example, up to three times or up to five times as great as the charging power at the end of the charging cycle.

The maximum permissible charging power is dependent on the type (design and chemistry) of the battery. The internal resistance of the battery causes a power loss during the charging process, which leads to heating. The battery temperature accordingly has to remain below a limit value in order not to reduce the lifetime.

The internal resistance that is variable over the charging process can be determined, for example, by ascertaining the ratio between (charging voltage-no-load voltage) and the charging current.

The no-load voltage can be determined repeatedly during the charging process. If the state of charge changes in the course of the charging process, specifically the no-load voltage also changes. The charging current can thus be tracked easily in order that essentially the desired charging power, for example the maximum permissible charging power of the battery, is used at any time.

For example, the no-load voltage can be determined more often than every ten minutes, for example every five minutes, every two minutes or once per minute, during the charging process. Even if the battery that is to be charged is a battery that can be charged particularly quickly, the no-load voltage during the charging process changes only slowly and, for example within the mentioned intervals, only slightly so that the charging voltage can be set sufficiently accurately through tracking of the charging current and, for example, can be kept substantially constant.

In order to be able to measure the no-load voltage of the battery easily, the flow of the charging current to the battery during the charging process can be interrupted for the purpose of determining the no-load voltage. Using this method, the battery can nevertheless be charged more quickly on account of the possible charging power that is higher compared to the CCCV method.

For example, for the purpose of determining the no-load voltage, the flow of the charging current can be interrupted for less than one second, less than half a second and, for example, for 100 milliseconds. A short interruption of the charging current of this kind makes it possible to measure the no-load voltage sufficiently accurately without unnecessarily extending the time required for charging.

In comparison to the duration of an uninterrupted stage of the charging process during which the battery is charged using charging current in uninterrupted fashion, the duration of the charging current interruption is less than 5%, less than 2%, less than 1%, less than 0.5% or even less than 0.01% of the duration of the uninterrupted stage.

In order that the battery can be charged using the respective maximum possible charging power, the maximum possible charging power can be ascertained based on a property of the battery during the charging process. The maximum possible charging power is in this case the charging power that can be used to charge the battery easily and, for example, without damaging or reducing the lifetime.

In particular, the charging current can be reduced when the property is outside of its permissible operating interval, as a result of which the charging power can be monitored easily.

For example, the temperature of the battery can be ascertained. If the temperature increases above a limit value, the charging power, that is to say, in particular, the charging current, can be reduced.

The temperature on the outer side of the battery can be measured as the battery temperature. For more accurate determination of the battery temperature, the temperature inside the battery and preferably centrally in the battery can be measured. A temperature sensor, which is arranged, for example, between two cells of the battery centrally in the battery, can be provided at the location of the measurement. The measurement of the battery temperature inside the battery is therefore complex in terms of design. The temperature is therefore preferably measured eccentrically and, for example, on the outer side of the battery and the battery temperature inside the battery is determined mathematically based on the measured temperature and known physical properties of the battery.

However, the use of the temperature of the battery has the disadvantage that a temperature sensor has to be provided for the temperature measurement. In order to be able to determine the maximum possible charging power even without a temperature sensor, the internal resistance of the battery during the charging process can be determined as a property.

To determine the internal resistance, the no-load voltage ascertained during the charging process can be subtracted from the charging voltage and the result can be divided by the charging current. If the no-load voltage, the charging voltage and the charging current are monitored during the charging process, no further measurement data therefore need to be compiled.

In order to be able to measure the no-load voltage easily, the apparatus can have a voltage meter for measuring the no-load voltage of the battery that is to be charged. The voltage meter can in this case be connected simply in parallel with the charging contacts of the apparatus. The voltage meter can be a voltmeter, for example.

The charging voltage can likewise be determined using the voltage meter so that the apparatus can be designed in a simple and compact manner.

To ascertain the internal resistance, the apparatus can have an internal resistance determination unit, which is connected to the voltage meter and to the control device in a signal-transmitting manner. Data that is representative of the charging voltage and/or the no-load voltage can be transmitted from the voltage meter to the internal resistance determination unit. Data that is representative of the charging current can be transmitted from the control unit to the internal resistance determination unit. The internal resistance is determined in the internal resistance determination unit, which can be, for instance, an integrated circuit, for example a microchip. The determined internal resistance can be output by the internal resistance determination unit to the control device. The control device can also be configured to be connectable to a battery temperature sensor.

After the disconnection of the charging current, it takes a certain amount of time until the battery voltage has dropped to the no-load voltage. In order to keep the interruption of the charging process as short as possible, a complete reduction in the battery voltage to the no-load voltage can be avoided. In particular, the profile of the battery voltage can be ascertained after the disconnection of the charging current and measured selectively, for example. When the profile of the battery voltage is known, the no-load voltage can be estimated or ascertained with the aid of a mathematical method based on the selective measurement values. For example, the battery voltage can fall exponentially after disconnection of the charging current. Based on the selective measurement values, the no-load voltage can be ascertained or estimated sufficiently accurately, for instance by a curve of best fit, without the battery voltage having to fall completely to the no-load voltage.

The control device can have a charging current limiter, which is connected to the internal resistance determination unit in a signal-receiving manner. The charging current limiter can limit the charging current based on the determined internal resistance in order to prevent excessively high charging powers.

In the following text, the invention is explained by way of example based on embodiments with reference to the drawings. The different features of the embodiments can in this case be combined independently of one another, as has already been stated in the individual advantageous refinements.

In the figures:

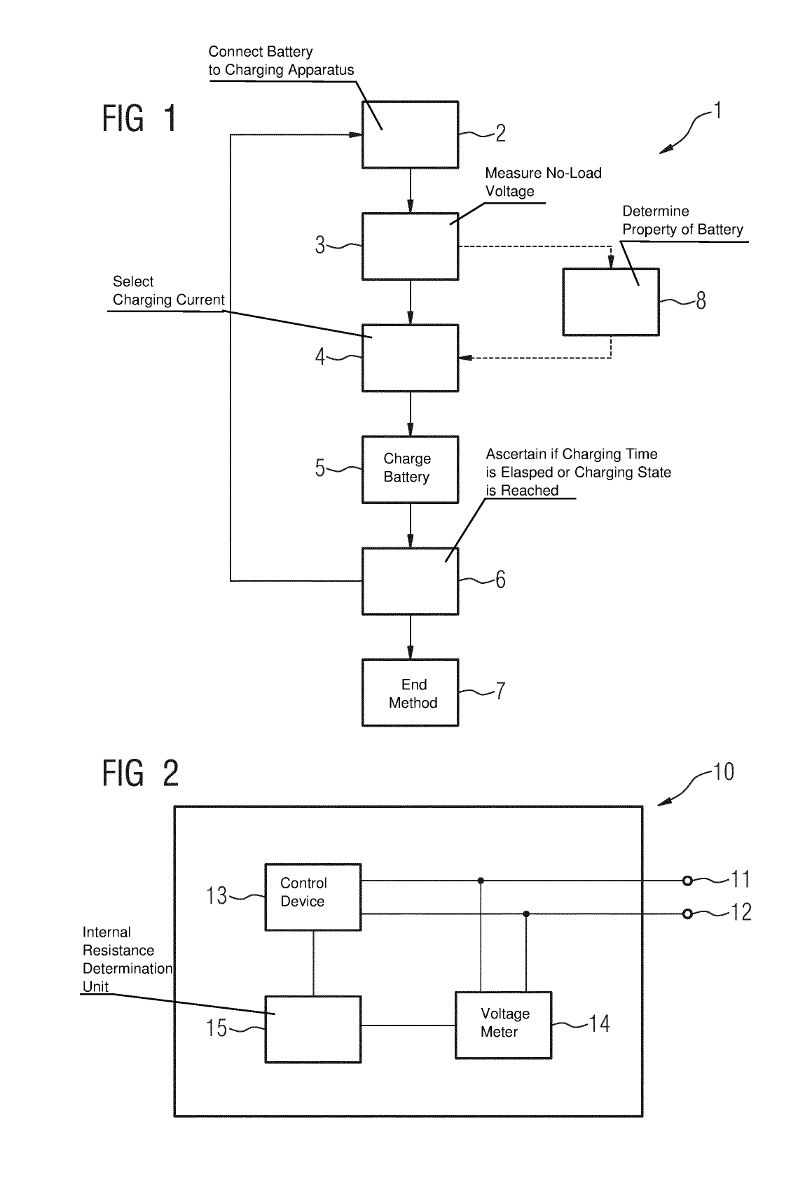

FIG. 1 shows a schematic illustration of an exemplary embodiment of the method according to the invention as a flow chart and

FIG. 2 shows a schematic illustration of an exemplary embodiment of the apparatus according to the invention.

FIG. 1 schematically shows the apparatus 1 according to the invention for charging a rechargeable battery as a flow chart. The method 1 starts with method step 2, in which the battery is connected to a charging apparatus, for example. Method step 3, in which the no-load voltage of a battery that is to be charged is measured, can follow method step 2, wherein the flow of the charging current can be interrupted during the measurement of the no-load voltage.

Method step 4, in which the charging current is selected so that the battery that is to be charged is charged using a prescribed charging power, can follow method step 3.

In method step 5, the battery can be charged using the selected charging current. In method step 6 that now follows, it is possible to ascertain whether a prescribed charging time has elapsed or a prescribed state of charge has been reached. If the prescribed state of charge, for example 100% or at least 95% or 90% of the maximum possible state of charge, of the battery has not yet been reached and if the prescribed charging time has elapsed, method step 3, in which the no-load voltage is measured again, can follow method step 6. Based on the no-load voltage measured in method step 3, the charging current can be selected anew in method step 4 carried out now and the battery can be charged further for the prescribed charging time in method step 5 using said newly selected charging current. If the desired state of charge is reached, method step 7, in which the method ends, can follow method step 6.

Method step 8, in which a property of the battery, for example the temperature or internal resistance thereof, is determined, can optionally initially follow method step 3. Method step 4, in which the charging current is selected taking into account the no-load voltage and the determined property of the battery, can then follow method step 8 again.

FIG. 2 schematically shows the apparatus 10 according to the invention for charging a rechargeable battery. The apparatus 10 has two charging contacts 11, 12 for connection of a battery that is to be charged. The apparatus 10 also has a control device 13, which can be used to monitor charging parameters, for example charging current and/or charging voltage. Furthermore, the apparatus 10 is provided with a voltage meter 14, which can be connected in parallel with the charging contacts 11, 12 in order to measure the voltage of a battery connected to the charging contacts 11, 12.

Furthermore, the apparatus 10 can have an internal resistance determination unit 15. The internal resistance determination unit 15 can be connected both to the voltage meter 14 and to the control device 13 in a signal-transmitting manner. The internal resistance determination unit 15 can determine the internal resistance of the battery that is to be charged as the property thereof based on the charging voltage and the charging current as well as the no-load voltage. To this end, the internal resistance determination unit 15 can receive from the voltage meter 14 data that is representative at least of the no-load voltage or else of the charging voltage. The internal resistance determination unit 15 can also receive from the control device 13 data that is representative of the charging current. Based on the received data, the internal resistance determination unit 15 can determine the internal resistance and, for example, calculate or estimate or determine same by way of a mathematical method, for example an algorithm. The internal resistance determination unit 15 can output data that is representative of the determined internal resistance to the control device 13. The internal resistance can be used in the control device 13 to prescribe the charging current.

The battery temperature can be measured, for example, using a temperature sensor. To determine the internal resistance of the battery, the difference of values for the no-load and the charging voltage can be divided by the charging current using the internal resistance determination unit 15.

The values of the no-load and the charging voltage as well as of the charging current can be represented by digital data or by analog signals. The apparatus 10 can be a control device for a vehicle, in particular an electrically driven vehicle, having a rechargeable battery that stores drive energy. The vehicle is, for example, a public service bus.

1-15. (canceled)

16. A method for charging a rechargeable battery, the method comprising the following steps:
charging the battery by using a charging current being dependent on a state of charge of the battery; and
determining a no-load voltage more often than every ten minutes during a charging process.

17. The method according to claim 16, which further comprises controlling the charging current so that a product of the charging current and the no-load voltage of the battery is substantially constant.

18. The method according to claim 16, which further comprises interrupting a flow of the charging current to the battery during the charging process for determining the no-load voltage.

19. The method according to claim 18, which further comprises carrying out the step of interrupting the flow of the charging current for less than one second for determining the no-load voltage.

20. The method according to claim 18, which further comprises carrying out the step of interrupting the flow of the charging current for a time period being less than 5% of a time of the charging process for determining the no-load voltage.

21. The method according to claim 17, which further comprises ascertaining the no-load voltage by applying a mathematical method.

22. The method according to claim 16, which further comprises ascertaining a maximum possible charging power to be used for readily charging the battery based on an internal resistance of the battery during the charging process.

23. The method according to claim 22, which further comprises reducing the charging current when the internal resistance is outside of a permissible operating interval.

24. The method according to claim 22, which further comprises determining the internal resistance by subtracting the no-load voltage ascertained during the charging process from a charging voltage and dividing a result of the subtraction by the charging current.

25. The method according to claim 16, which further comprises using a maximum permissible battery temperature of the battery during the charging process to determine a maximum possible charging power to be used for readily charging the battery.

26. An apparatus for charging a rechargeable battery, the apparatus comprising:
a voltage meter configured to measure a no-load voltage of a battery to be charged; and
a control device configured to monitor a charging current during operation of the apparatus
said control device being configured to:
charge the battery by using the charging current, the charging current being dependent on a state of charge of the battery; and
determine the no-load voltage more often than every ten minutes during a charging process.
